(19) United States
(12) Patent Application Publication
(10) Pub. No.: US 2016/0266367 A1
(43) Pub. Date: Sep. 15, 2016

(54) SINGLE MODE OPTICAL INPUT FOR IMAGING SYSTEM

(71) Applicant: Robert S. HODGE, Grants Pass, OR (US)

(72) Inventor: Robert S. HODGE, Grants Pass, OR (US)

(21) Appl. No.: 15/017,577

(22) Filed: Feb. 5, 2016

Related U.S. Application Data
(60) Provisional application No. 62/112,496, filed on Feb. 5, 2015.

(51) Int. Cl. G02B 21/02; F21V 8/00

(52) U.S. Cl. CPC G02B 21/02; G02B 6/0008

(57) ABSTRACT

An illumination system for illuminating a region within a field of view of an imaging device with a spot from a laser.

### CROSS-REFERENCE TO RELATED APPLICATION

This application claims the benefit under 35 USC §120 of U.S. Provisional Application No. 62/112,496 filed on Feb. 5, 2015, the entire disclosure of which is incorporated by reference herein for all purposes.

### BACKGROUND OF THE INVENTION

The subject matter of this application relates to optical systems that allow magnification of an image to be viewed.

Optical systems such as microscopes commonly used for research and development require a specimen being imaged be properly illuminated in order to obtain a quality image. Though early illumination techniques relied upon ambient light such as the sun to provide a source of illumination, such ambient illumination is typically inappropriate for a vast array of modern microscope applications. Thus, modern illumination systems include dedicated light sources so that the properties of the light, such as wavelength, intensity, diffusion, etc. may be tightly controlled to match the specific application for which the microscope is intended to be used.

Such dedicated light sources range in design and complexity from relatively simple halogen lamps with diffusers to uniformly backlight the specimen being magnified, to highly complex illumination systems such as darkfield illumination systems that rely on diffraction and/or reflection through the specimen itself to provide illumination through the eyepiece, multi-colored LED illumination systems for color imaging applications such as those disclosed in U.S. Pat. No. 2007/0211460 to Ravkin, electron microscopes which use accelerated electrons as a source of illumination, etc.

One type of illumination system for microscopes or other imaging systems uses lasers to direct light to the subject being magnified, typically as a very small spot focused by a collimator and often on a selected portion of the full field of view of the microscope or other imaging system. Projecting and positioning a laser spot that covers a portion of the field of view in a microscope is very useful in applications that include, but are not limited to biological research, materials processing, and any application where positioning a small-sized laser spot is required. Laser illumination is also a useful tool for a variety of optical techniques such as optical trapping and total internal reflection fluorescence.

The equipment necessary to direct a laser on a small spot, which may be a size on the order of several microns in diameter, has been very cumbersome, making laser illumination systems difficult and costly to configure. Even with a laser and the required beam control components, precisely positioning the spot at a desired location within the field of view of the microscope, requires complex equipment.

What is desired, therefore, is an improved system for using a laser to illuminate the subject of a microscope or other optical system.

### BRIEF DESCRIPTION OF THE DRAWINGS

For a better understanding of the disclosure, and to show how the same may be carried into effect, reference will now be made, by way of example, to the accompanying drawings, in which:

FIG. 1 shows schematically an improved illumination system for projecting and positioning a laser within a field of view of an imaging system.

FIG. 2 shows a microscope implementing the system of FIG. 1.

### DETAILED DESCRIPTION

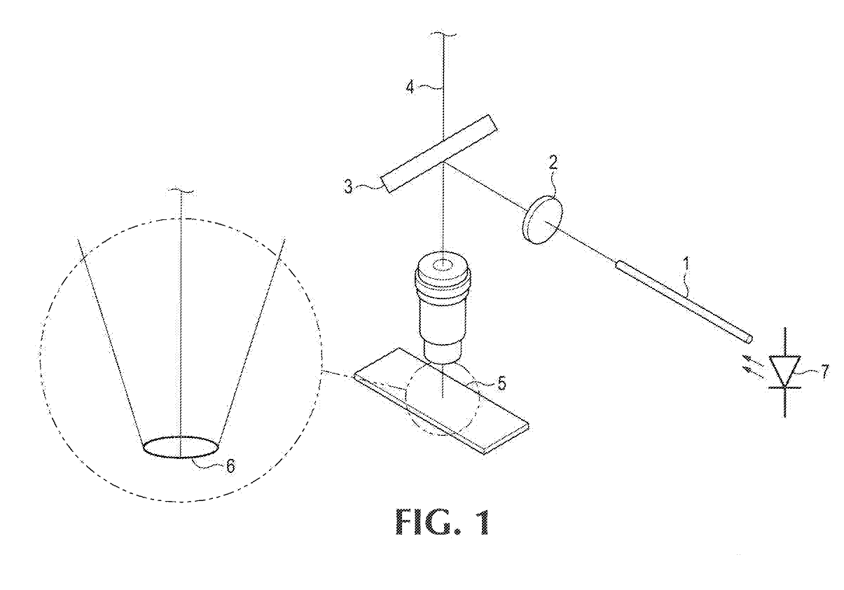

Referring to FIG. 1, an improved illumination system for projecting and positioning a laser beam within a field of view of an imaging system may comprise a fiber 1 for receiving light output from a laser 7 and propagating it to a collimating lens 2. The fiber 1 is preferably a single mode fiber. Similarly, the laser 7 should preferably be a single mode laser. Where single mode optical fiber is used, its diameter should preferably be less than approximately 20 microns, and preferably approximately 10 microns or less. The use of the word “approximately in this context means within five percent. The collimating lens 2 is preferably an aspheric lens.

The collimated output is provided to a beam splitter 3 which directs a first part of the light from the laser 7 to a camera or other light sensing device (not shown), and directs a second part of the light from the laser 7 towards an imaging sample 5 on a slide for example. The collimated output of the laser 7 may be used to illuminate the imaging sample 5 limited to a small spot at a selected location within the field of view 6 of the imaging system, using an adjustment mechanism as described later in this specification.

By using a single-mode fiber between a laser and a collimating lens of a microscope or other imaging system, small-diameter, well-defined spots can be illuminated, and at diminished complexity of the optical system because the single mode fiber minimizes the dispersion of the light from the laser as it travels along the fiber. Using multimode fiber would conversely have the undesired effect of flooding the field of view beyond the specific region desired to be illuminated, because the collimating lens 2 would be overwhelmed by the divergence of the dispersed light coming from the multi-mode fiber, resulting in a too-large region of illumination and thus not producing a well-defined spot.

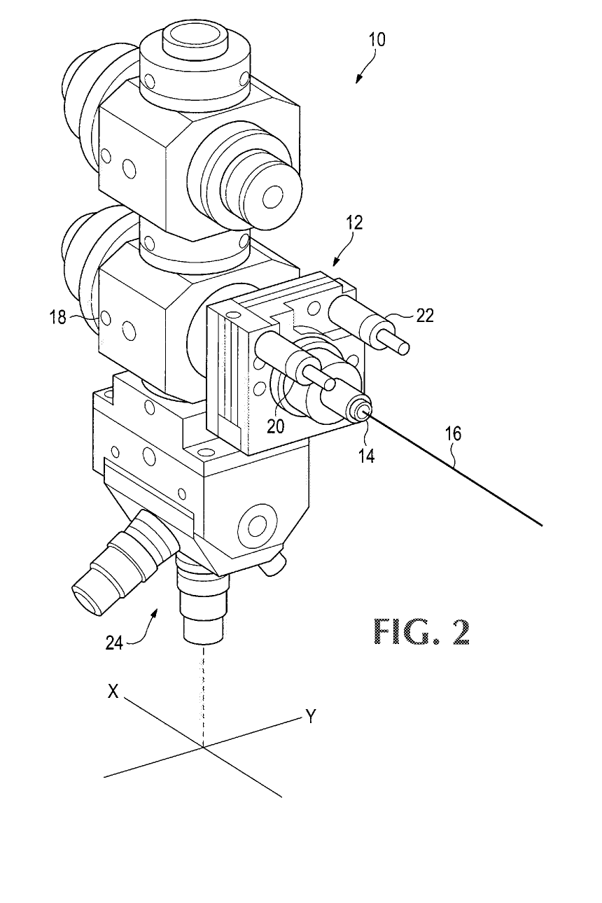

FIG. 2 shows an exemplary microscope 10 that may be retrofitted to implement the system shown in FIG. 1 on any infinity-corrected microscope by including a mount 12 having an input 14 for a single mode fiber 16 that provides laser light output to a collimating lens that collimates the light output of the single-mode fiber 16. The output of the collimating lens is provided to the beam splitter 3 within the housing 18, which in turn directs the collimated light upwards to a camera or other imaging device, and downward to an imaging sample. Preferably, the mount 12 includes an X axis adjustment screw 20 and a Y axis adjustment screw 22 so that the light spot provided by the input 14 may be moved about the field of view on a specimen slide below a 4°×360° Beam-Tilt Cone 24.

Although FIG. 2 has been used to illustrate a system that may be retrofitted to an existing microscope, it should be understood that some embodiments may comprise microscopes or other imaging systems that were manufactured to implement the system schematically shown in FIG. 1.

It will be appreciated that the disclosure herein is not restricted to the particular embodiment that has been described, and that variations may be made therein without departing from the scope of the disclosure as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A device comprising:
an optical system that illuminates a selected region within a field of view of an imaging device with a spot from a laser; and
an input that receives light from the laser through a single mode fiber.

2. The device of claim 1 including a collimating lens that receives light output from the single mode fiber.

3. The device of claim 2 including a beam splitter that receives collimated light from the collimating lens and directs a first part of the collimated light toward a sensing device and directs a second part of the collimated light towards the field of view.

4. The device of claim 1 where the single mode fiber has a diameter less than approximately 20 microns.

5. The device of claim 4 where the single mode fiber has a diameter less than approximately 10 microns.

6. The device of claim 1 including an adjustment mechanism capable of moving the spot to different regions within the field of view.

7. The device of claim 6 where the adjustment mechanism is capable of moving the spot in a selected at least one of two dimensions.

8. A method comprising
receiving light from a laser through a single mode fiber; and
illuminating only a selected region within a field of view of an imaging device with the light received from the laser.
an input that receives light from the laser through a single mode fiber.

9. The method of claim 8 including a collimating the light from the single mode fiber.

10. The device of claim 9 including splitting the collimated light to direct a first part of the collimated light towards a sensing device and to direct a second part of the collimated light towards the field of view.

11. The device of claim 8 where the single mode fiber has a diameter less than approximately 20 microns.

12. The device of claim 11 where the single mode fiber has a diameter less than approximately 10 microns.

13. The device of claim 8 including moving the spot to a selected region within the field of view.

14. The device of claim 13 including moving the spot in a selected at least one of two dimensions within the field of view.

15. A device capable of being selectively retrofitted to an imaging system that illuminates a field of view with light from a laser, the device comprising:
an input port adapted to receive light from a single mode fiber; and
an interface selectively attachable to and detachable from a housing of the imaging system, the housing including a beam splitter capable of receiving collimated light and directing a first part of the collimated light toward a sensing device and directing a second part of the collimated light towards the field of view.

16. The device of claim 15 including a collimating lens that receives light output from the single mode fiber.

17. The device of claim 16 including an adjustment mechanism capable of moving a spot produced by the collimating lens to different regions within the field of view.

18. The device of claim 17 where the adjustment mechanism is capable of moving the spot in a selected at least one of two dimensions.

19. The device of claim 16 where the collimating lens collimates light having a diameter less than approximately 20 microns.

20. The device of claim 19 where the collimating lens collimates light having a diameter less than approximately 10 microns.
